(19) United States
(12) Patent Application Publication
(10) Pub. No.: US 2014/0018208 A1
(43) Pub. Date: Jan. 16, 2014

(54) DRIVE FORCE DISTRIBUTING APPARATUS

(71) Applicant: NISSAN MOTOR CO., LTD., Yokohama-shi (JP)

(72) Inventors: Tetsu TAKAISHI, Chigasaki-shi (JP); Atsuhiro MORI, Fujisawa-shi (JP); Shunichi MITSUISHI, Isehara-shi (JP); Eigo SAKAGAMI, Kawasaki-shi (JP); Katsuyoshi OGAWA, Yokohama-shi (JP)

(73) Assignee: NISSAN MOTOR CO., LTD., Yokohama-shi (JP)

(21) Appl. No.: 13/928,747

(22) Filed: Jun. 27, 2013

(30) Foreign Application Priority Data
Jul. 12, 2012 (JP) 2012-156117

(51) Int. Cl. B60K 23/00

(52) U.S. Cl. CPC B60K 23/00
USPC 477/36

(57) ABSTRACT

A drive force distributing apparatus includes a first roller that is rotatable with a main drive wheel system and a second roller that is rotatable with a subordinate drive wheel system. Control of the drive force distribution between the main drive wheel system and the subordinate drive wheel system is carried out by turning the second roller by the rotation of a crankshaft to thereby adjust a radial pressing force of the second roller against the first roller by an adjustment mechanism. The adjustment mechanism includes a pinion shaft in meshed engagement with the crankshaft, a first output gear fitted to the pinion shaft, and a second output gear meshed with the first output gear and driven to rotate by a motor. A rotation angle sensor is provided to detect a variation in teeth of the first output gear to detect a rotation angle of the first output gear, whereby control of the drive force distribution is performed based on the detected rotation angle of the first output gear.

### CROSS-REFERENCE TO RELATED APPLICATIONS

This application claims priority under 35 U.S.C. §119 to Japanese Patent Application, No. 2012-156,117 filed Jul. 12, 2012. The entire disclosure of Japanese Patent Application No. 2012-156,117 is incorporated herein by reference.

### BACKGROUND OF THE INVENTION

1. Field of the Invention

The present invention generally relates to a vehicle drive force distributing apparatus. More particularly, the present invention relates to a vehicle drive force distributing apparatus suitable for a transfer of a four-wheel drive vehicle.

In the Japanese Laid-open Patent Publication No. 2012-11794 (and corresponding U.S. Patent Application Publication No. 2011/0319223 A), an example of a conventional drive force distributing apparatus is disclosed. The conventional drive force distributing apparatus shown is provided with a first roller mechanically coupled to a transmission system of main drive wheels and a second roller mechanically coupled to a drive system of sub-drive or subordinate wheels. The apparatus operates the first roller and the second roller to make contact with each other at their outer peripheral surfaces to distribute a part of a torque being transmitted to the main drive wheel to the subordinate drive wheel. Accordingly, a torque transmission capacity between the rollers can be controlled by adjusting a radial pressing force between the first roller and the second roller. The torque transmission capacity therefore controls the distribution of the drive force between the main drive wheel and the sub-drive wheel.

Such a mechanism for carrying out the drive force distributing control is proposed in the above referenced document, and, by radially displacing a second roller relative to a first roller with the shaft portion of the second roller circling by motor about a fixed shaft axis of housing, the radial depression force between the first roller and the second roller will be adjusted to effect the control drive force distribution between the main drive wheel and subordinate or driven wheel.

More specifically, such a structure is proposed in which the outer periphery of a hollow crankshaft is disposed to be rotatable about the fixed shaft axis of the housing, and the shaft portion of the second roller is rotatably supported on an eccentric hollow bore within the hollow crank shaft so that, by causing the second roller to rotate about the fixed shaft axis by the rotation of the crankshaft about the fixed shaft axis to thereby adjusting the pressing force of the second roller exerted against the first roller, the drive force distribution control is able to be performed between the main drive wheel and sub-drive wheel.

2. Summary of the Invention

Here, in order to control the motor for controlling the radial pressing force, it is necessary to determine the rotation angle of the crankshaft to secure the pressing force with high accuracy.

In view of the above, an object of the present invention is to provide a drive force distributing apparatus that may determine the rotation angle of the crankshaft.

In an embodiment, the invention provides a drive force distributing apparatus includes a first roller that is rotatable jointly with a main drive wheel system and a second roller that is rotatable jointly with a subordinate drive wheel system in which a drive force distribution to the subordinate drive wheel system is enabled by contacting the first roller and the second roller between respective outer peripheral surfaces of the first roller and the second roller. A shaft portion of the second roller is rotatably supported in an eccentric bore of a crankshaft that in turn is rotatable about a fixed shaft axis of a housing, and control of the drive force distribution between the main drive wheel system and the subordinate drive wheel system is carried out by turning the second roller by the rotation of the crankshaft about the fixed shaft axis to thereby adjust a radial pressing force of the second roller against the first roller by an adjustment mechanism. The adjustment mechanism includes a pinion shaft in meshed engagement with the crankshaft, a first output gear fitted to the pinion shaft, and a second output gear meshed with the first output gear and driven to rotate by a motor. A rotation angle sensor is provided to detect a variation in teeth of the first output gear to detect a rotation angle of the first output gear, whereby control of the drive force distribution is performed based on the detected rotation angle of the first output gear.

Therefore, the rotation angle of the crankshaft may be detected. In addition, since the rotation angle may be detected based on variations in gear teeth of the first output gear without providing a dedicated or separate rotational body for detection of the rotation angle, the apparatus may be made compact at low cost.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 is a schematic top plan view of an example of a power train of a four-wheel drive vehicle equipped with a drive force distributing apparatus according to a first embodiment of the invention;

FIG. 2 is a vertical cross-sectional side view of the drive force distributing apparatus shown in FIG. 1;

FIG. 3 is a vertical cross-sectional front view of a crankshaft used in the drive force distributing apparatus;

FIGS. 4A through 4C are a series of views illustrating operation diagrams of the drive force distributing apparatus shown in FIG. 2, with FIG. 4A illustrating an operation diagram in which the first roller and the second roller are separated from each other at crankshaft rotation angle at reference position of “0” degrees, FIG. 4B illustrating an operation diagram in which the first roller and the second roller are in a contact state at 90 degrees, and FIG. 4C illustrating the contact state between the first roller and the second roller at a crankshaft angle of 180 degrees.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

“First Embodiment”

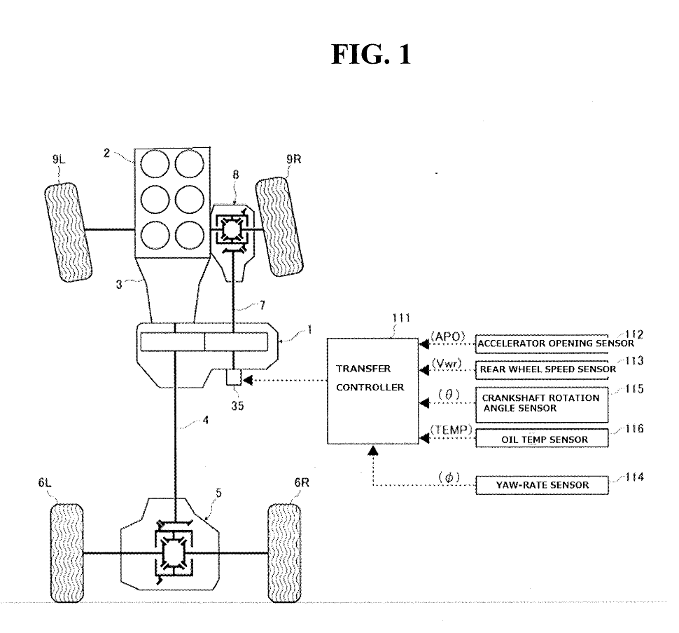

FIG. 1 is a schematic top plan view of a power train of a four-wheel drive vehicle equipped with a drive force distributing apparatus 1 according to a first disclosed embodiment. In this embodiment, the drive force distributing apparatus 1 can operate as a transfer case. The basic structure is disclosed in Applicant's own U.S. Patent Application Publication No. 2011/0319223 A, which is incorporated by reference herein.

The four-wheel drive vehicle is based on a rear wheel drive configuration in which torque from an engine 2 is multiplied by a transmission 3 and is transferred through a rear propeller shaft 4 and a rear final drive unit 5 to left and right rear wheels 6L and 6R.

The vehicle can operate in a four-wheel drive manner by using the drive force distributing apparatus 1 to divert a portion of the torque being provided to the left and right rear wheels (main drive wheels) 6L and 6R through a front propeller shaft 7 and a front final drive unit 8 to transmit torque to left and right front wheels (subordinate drive wheels) 9L and 9R.

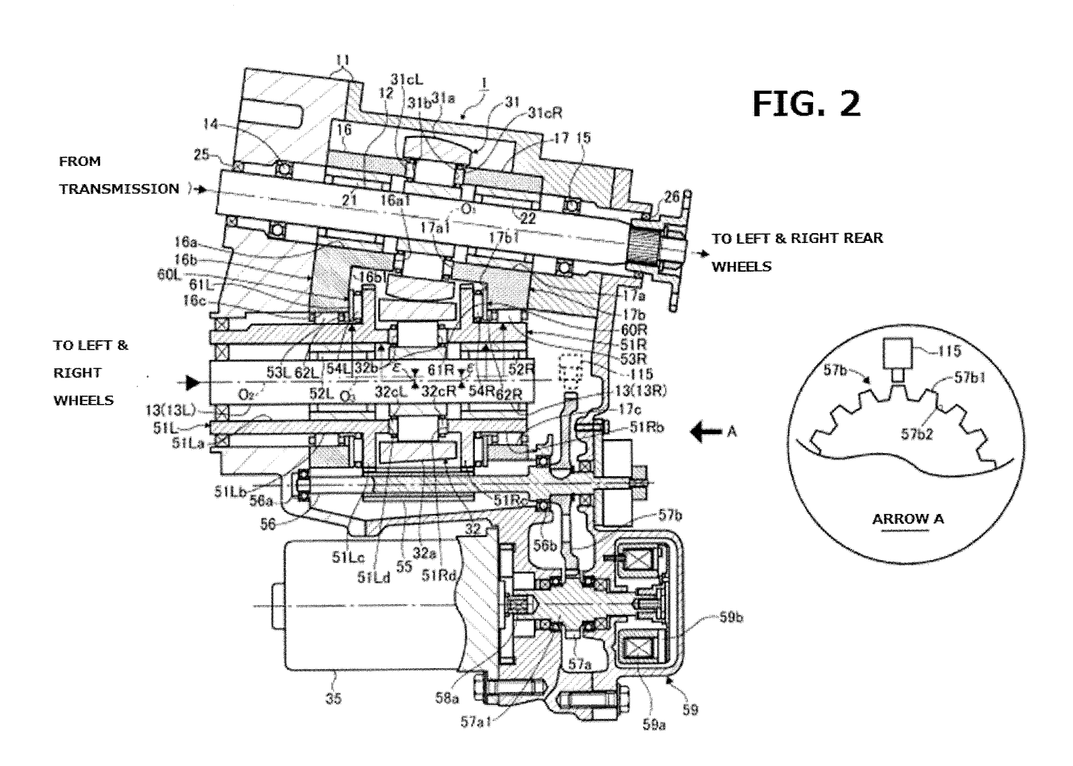

The drive force distributing apparatus 1 thus determines a drive force distribution ratio between the left and right rear wheels (main drive wheels) 6L and 6R and the left and right front wheels (subordinate drive wheels) 9L and 9R. In this embodiment, the drive force distributing apparatus 1 can be configured as shown in FIG. 2.

That is, as shown in FIG. 2, the apparatus includes a housing 11. An input shaft 12 and an output shaft 13 are arranged to span across an inside of the housing 11 diagonally with respect to each other such that a rotational axis O₁ of the input shaft 12 and a rotational axis O₂ of the output shaft 13 intersect each other. The input shaft 12 is rotatably supported in the housing 11 on ball bearings 14 and 15 located at both ends of the input shaft 12. Furthermore, both ends of the input shaft 12 protrude from the housing 11 and are sealed in a liquid-tight fashion or a substantially liquid-tight fashion by seal rings 25 and 26. In this arrangement, one end of the input shaft 12 shown at the left side of FIG. 2 is coupled to an output shaft of the transmission 3 (see FIG. 1). Also, the other end of the input shaft 2 at the right side of FIG. 2 is coupled to the rear final drive unit 5 through the rear propeller shaft 4 (see FIG. 1).

In addition, a pair of bearing supports 16 and 17 are provided between the input shaft 12 and the output shaft 13 in positions near the ends of the input shaft 12 and the output shaft 13. The bearing supports 16 and 17 are fastened to axially opposite internal walls of the housing 11 with fastening bolts (not shown), at approximate middle portions of the bearing supports 16 and 17. Bearing support 16, 17 is provided with an input shaft through bore 16a, 17a, output shaft through bore 16c, 17c for passing through the output shaft 13 and crankshaft 51L, 51R, and a vertical wall 16b, 17b connecting between the input shaft through bore 16a, 17a and output shaft through bore 16c, 17c, and is generally shaped in the axial direction front view. Roller bearings 21, 22 are arranged between the bearing supports 16, 17 and input shaft 12 for supporting the input shaft 12 freely or rotatably relative to bearing supports 16, 17 so that input shaft 12 is supported inside the housing 11 rotatably through the bearing supports 16, 17 as well.

A first roller 31 is formed integrally and coaxially with the input shaft 12 in an axially intermediate position located between the bearing supports 16 and 17, that is, between the roller bearings 21 and 22. A second roller 32 is formed integrally and coaxially with the output shaft 13 in an axially intermediate position such that the second roller 32 can make frictional contact via working oil with the first roller 31 in a power transmittable way. Naturally, the first roller 31 can instead be attached to the input shaft 12 in any suitable manner instead of being integral with the input shaft 12. Likewise, the second roller 32 can instead be attached to the output shaft 13 in any suitable manner instead of being integral with the input shaft 12. The outer circumferential surfaces of the first roller 31 and the second roller 32 are conically tapered in accordance with the diagonal relationship of the input shaft 12 and the output shaft 13 such that the outer circumferential surfaces can contact each other without or substantially without a gap between the surfaces. At both sides of radial extension of the first roller 31 and the second roller 32 are formed with retention grooves 31b, 32b to contact with and retain radially thrust bearings 31c1, 31cR, 32c1, 32cR. The thrust bearings 31cL, 31cR position first roller 31 by contacting the first side walls 16a1, 17a1 of bearing supports 16, 17. On the other hand, the thrust bearings 32cL, 32cR position second roller 32 by contacting the roller side contact portions 51Ld, 51Rd of crankshaft 51L, 51R described below.

The output shaft 13 is rotatably supported with respect to the bearings supports 16 and 17 at positions near both ends of the output shaft 13. Thus, the output shaft 13 is rotatably supported inside the housing 11 through the bearing supports 16 and 17. A support structure used to support the output shaft 13 rotatably with respect to the bearing supports 16 and 17 is realized by an eccentric support structure as will now be explained.

As shown in FIG. 2, a crankshaft 51L configured as a hollow outer shaft is moveably fitted between the output shaft 13 and the bearing support 16. Also, a crankshaft 51 R configured as a hollow outer shaft is moveably fitted between the output shaft 13 and the bearing support 17. The crankshaft 51L and the output shaft 13 protrude from the housing 11 as shown on the left side of FIG. 2. At the protruding portion, a seal ring 27 is installed between the housing 11 and the crankshaft 51L. Also, a seal ring 28 is installed between the crankshaft 51L and the output shaft 13. The seal rings 27 and 28 serve to seal the portions where the crankshaft 51 L and the output shaft 13 protrude from the housing 11 in a liquid-tight or substantially liquid-tight fashion.

The left end of the output shaft 13 protruding from the housing 11 in FIG. 2 is coupled to the front wheels 9L and 9R through the front propeller shaft 7 (see FIG. 1) and the front final drive unit 8.

A roller bearing 52L is arranged between a center hole or bore 51La (radius Ri) of the crankshaft 51L and a corresponding end portion of the output shaft 13. Also, a roller bearing 52R is arranged between a center hole 51Ra (radius Ri) of the crankshaft 51R and a corresponding end portion of the output shaft 13. Thus, the output shaft 13 is supported such that the output shaft 13 can rotate freely about the center axis O₂ inside the center holes 51La and 51Ra of the crankshaft 51L and 51R.

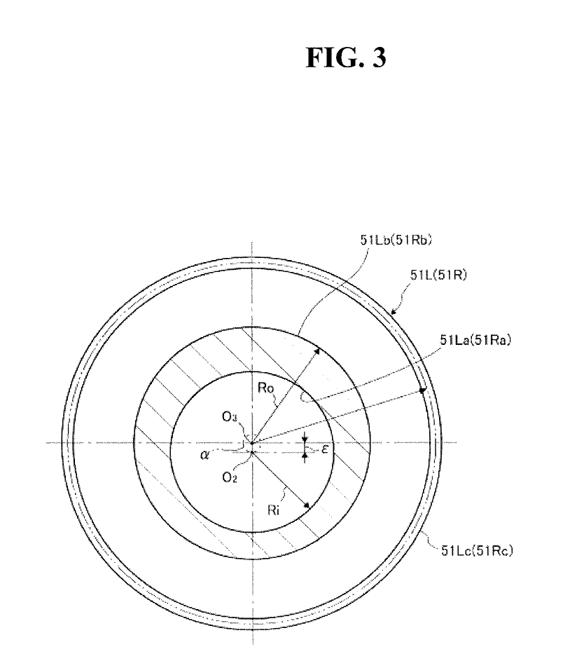

As shown clearly in FIG. 3, the crankshaft 51L has an outer circumferential portion 51Lb (center shaft axis O3, radius Ro) that is eccentric with respect to the center hole 51La. Also, the crankshaft 51R has an outer circumferential portion 51Rb (center shaft axis O3, radius Ro) that is eccentric with respect to the center hole 51Ra. The eccentric outer circumferential portions 51Lb and 51Rb are offset from the center axis (rotational axis) O₂ of the center holes 51La and 51Ra by an eccentric amount c. The eccentric outer circumferential portion 51Lb of the crankshaft 51L is rotatably supported inside the corresponding bearing support 16 through a roller bearing 53L. The eccentric outer circumferential portion 51Rb of the crankshaft 51R is rotatably supported inside the corresponding bearing support 17 through a roller bearing 53R. In addition, the roller side contact portions 51Ld, 51Rd of crankshafts 51L, 51R are freely and rotatably supported on thrust bearings 32cL, 32cR. Further, thrust bearings 54L, 54R are provided axially outside with respect to thrust bearings 32cL, 32cR. These thrust bearings 54L, 54R contact spacers 60L, 60R roratably and also contact ring gears 51Lc, 51Rc rotatably to thereby support crankshaft 51L and 51R rotatably fee.

Spacers 60L, 60R are composed of a first spacer portions 61L, 61R which respectively contacts the second wall surface 16b1, 17b1 of the vertical wall 16b, 17b facing the second roller 32 and respectively extends radially inwardly of output shaft through bore or hole 16c, 17c up to a position of contact free of the crankshaft 51L and a second spacer portions 62L, 62R (extension portion) that respectively extends to be inserted in the output shaft bore 16c, 17c. In addition, spacers 60L, 60R are positioned radially through contact between the outer periphery of the second spacer portions 62L, 62R and the inner periphery surface of output shaft through bores 16c, 17c while mutual interference between roller bearings 53L, 53R and thrust bearing 54R, 54L are avoided.

Crankshafts 51L, 51R are respectively formed integrally with ring gears 51Lc, 51Rc which face each other and provided at respective ends of the associated crankshaft. These ring gears 51Lc, 51Rc are each meshed with a common crankshaft drive pinion 55 such that the crankshaft pinion is coupled to pinion shaft 56.

The ring gears 51Lc and 51Rc are meshed with the crankshaft drive pinion 55 such that the eccentric outer circumferential portions 51Lb and 51Rb of the crankshafts 51L and 51R are aligned with each other in a circumferential direction. That is, the rotational positions of the eccentric outer circumferential portions 51Lb and 51Rb are in phase with each other.

Pinion shaft 56 is rotatably supported at its both ends on bearings 56a, 56b relative to housing 11. At the right end of pinion shaft 56, that is in the ride side in FIG. 2, a large diameter output gear 57b (first output gear) is fixed. At the side of outer diameter of the large diameter output gear 57b is provided a crankshaft rotation angle sensor 115 as shown by arrow A, which detects the protrusions and indents 57b1, 57b2 of teeth surfaces of the large diameter output gear 57b to detect the rotation angle of crankshaft 51L, 51R. The crankshaft rotation sensor 115 is a magnetic sensor to detect the protrusions and indents formed by the teeth of the large diameter output gear 57b and to detect the rotation angle of the pinion shaft 56 and that of crank shaft 51L, 51R. In the case of the rotation angle sensor of the type in which the teeth of the large diameter output gear 57b is detectable, as compared to the expensive arrangement such as a rotary encoder that requires components on both sides of the rotation body and the stator, the rotation angle may be detected with much more compact space at low cost. In addition, consideration may be given advantageously to the arrangement in which the sensor can be mounted from the outer periphery side of housing 11 which provides a spacious area around the periphery of the large diameter output gear 57b.

Further, at the outer periphery of the large diameter output gear 57b is provided in meshed relationship a small diameter output gear 57a (second output gear). The small diameter output gear 57a is integrally formed with the smaller diameter output gear shaft 57a1, and is mounted to the motor drive shaft 58a of motor 35 on the left end side in FIG. 2 for joint rotation with motor 35. In an embodiment, these components including crankshafts 51L, 51R, pinion shaft 56, large diameter output gear 57b, small diameter output gear 57a, small diameter output shaft 57a1 and inter-roller pressing force control motor 35 are described as an adjustment mechanism collectively.

On the right end side of the small diameter output gear shaft 57a1 is provided with an electromagnetic brake 59 to selectively stop the rotation of the small diameter output gear shaft 57a1. The electromagnetic brake 59 includes a coil 59a for generating magnetic force and a clutch plate 59b that is splined at the right end of the small diameter output gear shaft 57a1 for allowing an axial stroke.

An armature is provided on the clutch plate 59b. The clutch plate 59b moves axially due to electromagnetic attraction force to be fixed to yoke at the outer periphery of coil 59b in response to energizing of the coil 59a. When the electromagnetic clutch 59 is ON (engaged state), pinion shaft 56 may be fixed despite the application of torque on the side of pinion shaft 56 such that a predetermined inter-roller center distance may be maintained. On the other hand, when the electromagnetic clutch is in OFF state (released or disengaged state), the rotational movement of motor 35 may be transmitted to pinion shaft 56 to achieve a predetermined inter-roller center distance.

The rotational position control can be executed with respect to the crankshafts 51L and 51R by driving the crankshafts 51L and 51R with the inter-roller radial pressing force control motor 35 through the pinions 55 and the ring gears 51Lc and 51Rc. When this occurs, the output shaft 13 and the rotation axis O₂ of the second roller 32 turn about the center axis (rotational axis) O₃ so as to revolve or turn along a circular path a indicated with a broken line in FIG. 3.

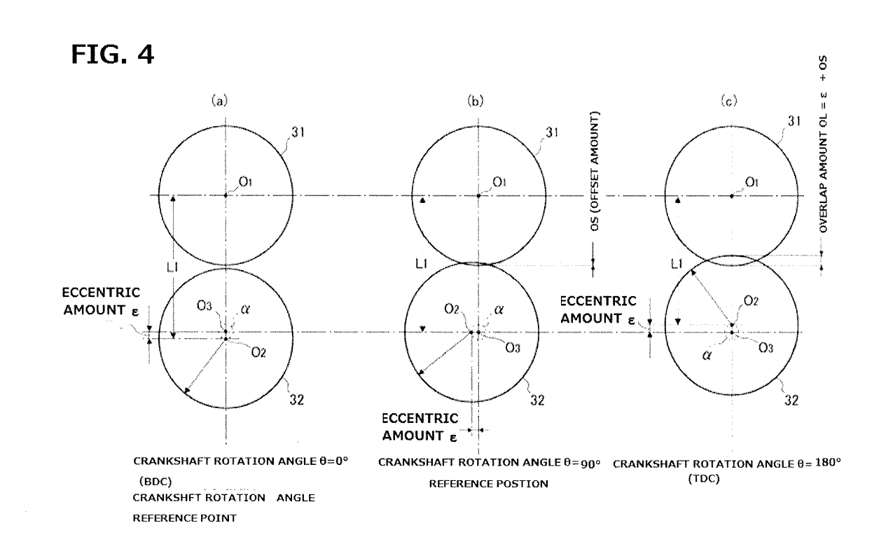

As will be described in detail later, by the turn or rotation of rotation shaft axis O2 (second roller 32) along a locus circle path a in FIG. 3, the second roller 32 approaches the first roller 31 as shown in FIGS. 4A to 4C in the radial direction. Thus, as the rotation angle θ of crankshafts 51L, 51R increases, the roller center distance L1 between the first roller 31 and the second roller 32 may be decreased to less than the sum of the radius of the first roller 31 and the radius of the second roller 32, which will cause the radial pressing force of the second roller 32 on the first roller 31 (inter-roller transmission torque capacity; traction transmission capacity) to be increased. Therefore, in response to the decrease in the inter-roller center distance L1, the inter-roller radial depressing force (inter-roller transmission torque capacity; traction transmission capacity) may be variably controlled to adjust the drive force distribution ratio freely.

Note that, as shown in FIG. 4A, in the present embodiment, the inter-roller center distance L1 in a state of bottom dead center in which the rotation shaft axis O2 is located directly below the rotation axis O3 of crankshaft and the inter-roller distance between first roller 31 and second roller 32 becomes maximum is configured to be larger than the sum of the radius of first roller 31 and the radius of the second roller 32. Thus, at the bottom dead center with crankshaft rotation angle being “0” degrees, the first roller 31 and the second roller 32 are prevented from being pressed against each other in a radial direction so that such a state may be provided in which no traction transmission between rollers 31, 32 takes place, i.e., traction transmission capacity being “0”. Therefore, traction capacity may be set arbitrarily to a value anywhere between “0” at the bottom dead center and the maximum value obtainable at the top dead center in FIG. 4C (i.e., θ=180 degrees). In the present embodiment, description is made by setting a rotation angle reference of crankshaft 51L, 51R at the bottom dead center, i.e., crankshaft rotation angle being “0”.

<Operation of Drive Force Distribution>

With reference to FIGS. 1 to 4, the operation of the drive force distribution is now described. An output torque from the transmission 3 (shown in FIG. 1) is imparted to input shaft 12 of transfer case 1. The torque can be further transmitted directly from the input shaft 12 to the left and right rear wheels 6L and 6R (main drive wheels) through the rear propeller shaft 4 and the rear final drive unit 5 (both being shown in FIG. 1).

Also, when the inter-roller distance L1 (shown in FIG. 4) is set less than the sum of the radius of first roller 31 and the radius of second roller 32 in response to the rotation position control of crankshafts 51L, 51R by motor 35 through pinion 55 and ring gears 51Lc, 51Rc, the transfer case 1 acquires an inter-roller transmission torque capacity in accordance with the radial pressing force between first roller 31 and second roller 32. Depending on this torque capacity, transfer case 1 can divert a portion of the torque from the left and right rear wheels 6L and 6R (main drive wheels) toward the output shaft 13 by passing torque from the first roller 31 to the second roller 32. A torque reaching the output shaft 13 is transmitted to drive the left and right front wheels (subordinate drive wheels) 9L and 9R. Therefore, the vehicle can be operated in a four-wheel drive mode in which the left and right rear wheels 6L and 6R (main drive wheels) and the left and right front wheels (subordinate drive wheels) 9L and 9R are driven.

Note that, during torque transmission, a reaction force of the radial pressing force between first roller 31 and second roller 32 are received by bearing supports 16, 17 without reaching housing or case 11. Further, the reaction force of the radial pressing force remains “0” when the crankshaft rotation angle is within a range between 0 and 90 degree, increases in accordance with increase in crankshaft rotation angle θ between 90 and 180 degrees, and will assume the maximum value at the crankshaft rotation angle θ being 180 degrees.

During travel in the four-wheel drive mode, when the rotation angle θ of crankshaft 51L, 51R is set at a reference position of 90 degrees, the first roller 31 and second roller 32 are pressed against each other for frictional contact at a radial pressing force corresponding to an offset amount OS at this time, torque transmission takes place to left and right front wheels (subordinate drive wheels) 9L, 9R in accordance with the offset value OS between the two rollers.

As the rotation angle θ of crankshaft 51L, 51R increases from the reference position shown in FIG. 4B toward the top dead center with crankshaft rotation angle θ being at 180 degrees as shown in FIG. 4C, the inter-roller center distance L1 further decreases to increase the overlap amount OL between first roller 31 and second roller 32. Consequently, the radial pressing force between first roller 31 and second roller 32 will be increased to thereby increase the traction transmission capacity between these rollers.

When crankshafts 51L, 51R have reached the position of top dead center shown in FIG. 4C, first roller 31 and second roller 32 are pressed at the maximum radial pressing force corresponding to the maximum overlap amount OL so that the traction transmission capacity between the two will be made maximum. Note that the maximum overlap amount OL is obtained by adding the eccentric amount E between the second roller rotation axis O2 and crankshaft rotation axis O3 to the offset amount OS described with reference to FIG. 4B.

As will be appreciated from the description above, by operating crankshafts 51 L, 51R to rotate from the position of “0” crankshaft rotation angle to the position of “180” crankshaft rotation angle, an inter-roller traction transmission capacity may be varied continuously from “0” to maximum. Conversely, by operating crankshafts 51L, 51R to rotate from the position of “180” crankshaft rotation angle to the position of “0” crankshaft rotation angle, the inter-roller traction transmission capacity may be varied continuously from maximum to “0”. Thus, the inter-roller traction transmission capacity may be controlled freely by the rotational operation of crankshafts 51L, 51R.

<Control of Traction Transmission Capacity>

During a four-wheel drive travel described above, transfer case 1 outputs and conveys a part of the torque t to left and right rear wheels (main drive wheels) 6L, 6R to left and right front wheels (subordinate drive wheels) 9L, 9R. Thus, the traction transmission capacity between the first roller 31 and the second roller 32 is required to correspond to a target front wheel drive force to be distributed to left and right front wheels (subordinate wheels) that is obtainable based on the drive force to left and right rear wheels (main drive wheels) 6L, 6R and the distribution ratio of front to rear wheel target drive force.

In the present embodiment, in order to perform a required traction transmission capacity control, a transfer controller 111 is provided shown in FIG. 1 to carry out control of the rotational position (control of rotation angel θ of crankshaft) of motor 35.

Therefore, transfer controller 111 receives a signal from accelerator pedal opening sensor 112 to detect the accelerator depressing amount (accelerator pedal opening degree) APO to adjust the output of engine 2, a signal from rear wheel speed sensor 113 to detect the rotational peripheral speed Vwr of left and right rear wheels 6L, 6R (main drive wheels), a signal of yaw-rate sensor 114 to detect a yaw-rate φ about the vertical axis passing through the center of gravity of the vehicle, a signal from the crankshaft rotation angle sensor 115 to detect the rotation angle θ of crankshaft 51L, 51R, and a signal of a oil temperature sensor 116 to detect a temperature TEMP of working oil within the transfer 1 (housing 11).

Based on the detection information of each sensor 112 to 116 described above, transfer controller 111 generally controls the traction transmission capacity (front to rear wheel drive force distribution control of four wheel drive vehicle) in the following manner.

Specifically, transfer controller 111 first obtains both the drive force of left and right wheels 6L, 6R (main drive wheels) and the front to rear target drive force distribution ratio in a known manner.

Subsequently, transfer controller 111 acquires a target front wheel drive force to be conveyed to left and right front wheels (subordinate wheels) 9L, 9R based on the drive force of left and right rear wheels 6L, 6R (main drive wheels) and the target distribution ratio between front and rear drive force.

Further, transfer controller 111 obtains a required radial inter-roller pressing force (traction transmission capacity) imparted by first roller 31 and second roller 32 necessary to transmit the target front drive force, and then calculates a target rotation angle tθ of crankshaft 51L, 51R (see FIGS. 2, 3), that is, target rotation angle of second roller axis O2 necessary to achieve the radial inter-roller pressing force (traction transmission capacity between first roller 31 and second roller 32).

Then, transfer controller 111 controls to drive the inter-roller pressing force control motor 35 such that crankshaft rotation angle θ matches the target crankshaft rotation angle tθ in accordance with the difference between the crankshaft rotation angle θ detected by sensor 115 and the target crankshaft rotation angle tθ. When the rotation angle θ of crankshaft 51L, 51R matches the target value tθ, the first roller 31 and the second roller 32 are pressed to each other to be capable of transmuting the target front wheel drive force and the first roller 31 and second roller 32 may be controlled to allow the traction transmission capacity to match the target front to rear wheel drive force distribution.

As has been described above, in the present embodiment, the following operational effects may be achieved.

Provided are a pinion shaft 56 in meshed engagement with crankshafts 51L, 51R, a large diameter output gear 57b (first output gear) fitted to the pinion shaft 56, a small diameter output gear 57a (second output gear) meshed with the large diameter output gear 57b and driven to rotate by a radial inter-roller pressing force control motor 35 (motor), and a crank shaft rotation angle sensor 115 (rotation angle sensor) to detect the variation in teeth of the large diameter output gear 57b to detect rotation angle, thereby controlling the drive force distribution based on the rotation angle of the large diameter output gear 57b detected.

In other words, the control of the inter-roller pressing force is key to the control of the drive force distribution. The pressing force between rollers is determined by an eccentric amount of the second roller 32, i.e., the rotation angle of crankshaft 51L, 51R. Thus, by detecting the variations associated with teeth of the large diameter output gear which is synchronized with the rotation angle of crankshaft 51L, 51R, it is not necessary to provide a separate rotation body for detecting the rotation angle. In addition, an inexpensive, magnetic type rotation sensor may be used for detector, a compact apparatus with low cost may be achieved. Further, because the sensor may be mounted from the outer periphery side of housing 11, increase in axial dimension is achieved. Moreover, advantageous arrangement in a spacious area in the outer periphery make the overall apparatus compact.

General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward, rearward, above, downward, vertical, horizontal, below and transverse” as well as any other similar directional terms refer to those directions of a device equipped with the present invention. Accordingly, these terms, as utilized to describe the present invention should be interpreted relative to a device equipped with the present invention. The term “detect” as used herein to describe an operation or function carried out by a component, a section, a device or the like includes a component, a section, a device or the like that does not require physical detection, but rather includes determining, measuring, modeling, predicting or computing or the like to carry out the operation or function. The term “configured” as used herein to describe a component, section or part of a device includes hardware and/or software that is constructed and/or programmed to carry out the desired function. Moreover, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A drive force distributing apparatus comprising:
a first roller that is rotatable jointly with a main drive wheel system and a second roller that is rotatable jointly with a subordinate drive wheel system in which a drive force distribution to the subordinate drive wheel system is enabled by contacting the first roller and the second roller between respective outer peripheral surfaces of the first roller and the second roller,
wherein a shaft portion of the second roller is rotatably supported in an eccentric bore of a crankshaft that in turn is rotatable about a fixed shaft axis of a housing, and control of the drive force distribution between the main drive wheel system and the subordinate drive wheel system is carried out by turning the second roller by the rotation of the crankshaft about the fixed shaft axis to thereby adjust a radial pressing force of the second roller against the first roller by an adjustment mechanism,
wherein the adjustment mechanism comprises
a pinion shaft in meshed engagement with the crankshaft;
a first output gear fitted to the pinion shaft; and
a second output gear meshed with the first output gear and driven to rotate by a motor, and
wherein a rotation angle sensor is provided to detect a variation in teeth of the first output gear to detect a rotation angle of the first output gear, whereby control of the drive force distribution is performed based on the detected rotation angle of the first output gear.

2. The drive force distributing apparatus according to claim 1, wherein a diameter of the first output gear is larger than a diameter of the second output gear.

3. The drive force distributing apparatus according to claim 2, wherein the rotation angle sensor detects peaks and valleys of the teeth of the first output gear.

4. The drive force distributing apparatus according to claim 3, wherein the rotation angle sensor is a magnetic sensor.

5. The drive force distributing apparatus according to claim 1, further comprising an elecromagnetic brake coupled to the second output gear.

6. The drive force distributing apparatus according to claim 1, further comprising a transfer controller configured to control a rotational angle of the crankshaft,
wherein as the rotation angle of the crankshaft is increased, a distance between a center of the first roller and a center of the second roller decreases to less than the sum of a radius of the first roller and a radius of the second roller, causing a radial pressing force of the second roller on the first roller to increase.

7. The drive force distributing apparatus according to claim 7, wherein the transfer controller is configured to
acquire a drive force of the main drive wheel system and a target drive force distribution ratio;
acquire a target drive force to be conveyed to the subordinate drive wheel system based on the drive force of the main drive wheel system and the target drive force distribution ratio;
acquire a required radial inter-roller pressing force imparted by first roller and second roller necessary to transmit the target drive force, and then calculate a target rotation angle of the crankshaft necessary to achieve the radial inter-roller pressing force; and
drive the motor such that crankshaft rotation angle matches the target crankshaft rotation angle based on the rotation angle detected by rotation angle sensor.
